(19) United States
(12) Patent Application Publication
(10) Pub. No.: US 2010/0134285 A1
(43) Pub. Date: Jun. 3, 2010

(54) METHOD OF SENSOR DATA FUSION FOR PHYSICAL SECURITY SYSTEMS

(75) Inventor: Kurt Holmquist, Lutz, FL (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/326,149

(22) Filed: Dec. 2, 2008

(51) Int. Cl. G08B 13/00

(52) U.S. Cl. 340/541

(57) ABSTRACT

A method of sensor data fusion in a physical security system of a monitored area is provided. The method comprises receiving data inputs from one or more sensors in the physical security system, with the monitored area being overlaid with a grid defining a plurality of locations. The method further comprise selecting one or more potential paths of one or more potential intruders through the monitored area using an iterative process, which takes into consideration a sequence of sensor inputs and assumed limitations on the mobility of the one or more potential intruders. A confidence metric is then produced for each selected potential path.

### BACKGROUND

Physical security systems that employ automated surveillance and/or intrusion detection, to secure a perimeter or volumetric area of a site, are intended to operate autonomously until an event occurs which indicates a possible security breach. At this point, a human operator is automatically alerted.

For any physical security system it is desirable to have low occurrences of false alarms and low occurrences of failures to detect an intruder. Measures taken to reduce one almost inherently increase the other. Failures to detect can be reduced by layering of sensors, that is, using multiple types of sensors and deploying them with overlapping detection areas. Simply “OR-ing” the detection outputs of these sensors then decreases detection failures but increases occurrences of false alarms. Of course, simply “AND-ing” the detection outputs of sensors with overlapping detection areas has the opposite effect.

While low in cost, the commonly used contact sensors (e.g., electric eyes), proximity sensors (e.g., passive infrared (PIR)), and video differential sensors, are all prone to high false alarm and nuisance alarm rates due to a variety of environmental and natural triggers. Such triggers include, for example, movements of small or large animals, wind blown debris, moving vegetation, temperature gradients, moving clouds, rain, snow, and moving water.

Many monitored sites are unattended and remotely located. Conventional security doctrine for military installations requires dispatching a team of military police to a site to directly assess the situation whenever a sensor is activated. False and nuisance alarms impose a significant cost in manpower and material. Sensitivities to smaller targets or environmental conditions can be reduced for existing sensors but only at the expense of reducing their ability to detect actual intrusions.

Accordingly, there is a need for improved security systems and methods that overcome the above deficiencies.

### SUMMARY

The present invention is related to a method of sensor data fusion in a physical security system of a monitored area. The method comprises receiving data inputs from one or more sensors in the physical security system, with the monitored area being overlaid with a grid defining a plurality of locations. The method further comprises selecting one or more potential paths of one or more potential intruders through the monitored area using an iterative process, which takes into consideration a sequence of sensor inputs and assumed limitations on the mobility of the one or more potential intruders. A confidence metric is then produced for each selected potential path.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIGS. 1-11 are flow diagrams representing various aspects of the algorithm of the invention.

### DETAILED DESCRIPTION

The present invention is directed to a method of sensor data fusion for physical security systems having automated surveillance and/or intrusion detection. The present method utilizes an algorithm for performing sensor data fusion in the physical security application to reduce the occurrence of false and nuisance alarms. The method intelligently considers the indications of a number of sensors as they occur over time, and uses the combined and processed inputs as the basis for determining the likelihood that an actual security breach has happened.

The subject invention is applicable to various physical security areas, allowing the use of any number and variety of detection devices, and supporting continuous autonomous operation. In addition, the present approach includes numerous techniques for reducing processing load in order to improve the feasibility of implementation.

In general, the algorithm of the invention selects a set of possible paths of one or more intruders through a monitored area that have the highest likelihood, taking into consideration a sequence of sensor observations and the assumed limitations on the mobility of a potential intruder. The algorithm produces a confidence metric for each selected path that can be used both for a subjective decision regarding an actual intrusion and to provide its relative significance versus other paths.

For example, if the security system is concerned with human intruders on foot, a bird flying through the area would not cause an alarm because its velocity would be well outside the limits of a human on foot. As another example, passive infrared sensors can be activated by wind motivated vegetation. However, these activations are unlikely to correspond to a sequence produced by a human moving deliberately through the area. The algorithm would therefore assign a low metric to paths of a target that could cause this observed sequence of activations. The assumed mobility limitation can include direction of travel and lower velocity limits (e.g., slowly moving cars versus cars moving at highway speeds).

The subject invention provides a way to consider the indications of a variety of sensor types including first generation sensors (e.g., direct contact sensors such as switches, magnetically activated relays, electric eyes, etc.), second generation sensors (e.g., remote sensing such as passive infrared, and microwave proximity such as buried cable and fence motion sensors), and third generation sensors that have target location estimating capabilities (e.g., radar, LIDAR (light detection and ranging), video analytics, and seismic sensor arrays). The indications are considered in a systematic and consistent manner that is transparent to the type of sensor. This allows the algorithm to be used with any suite of sensors and to be easily modified to include new types of sensors as they become available or as the suite of sensors in a particular installation is modified.

The algorithm of the invention overlays the area of interest with a grid and defines the “state” of the system to be the grid location of a potential target (intruder). The system has a finite set of discrete states where each state corresponds to a specific grid location. The system state can be expanded to include target velocity and even acceleration provided that these are quantized so that the complete state remains finite. A “possible” state of the system (since the actual state is unknown) at an iteration (point in time) is represented as a value from this set. Using the term “iteration” is more accurate than using the term “time” because there is no assumption regarding time relationships other than that time increases monotonically with each iteration.

The term “state[i]” used herein refers to one of a finite set of discrete non-overlapping and contiguous areas. In this sense, any location (set of x-y coordinates) has an associated state value which is the state value assigned to the distinct area of the grid containing that location. No matter where a target is actually located in the monitored area, it has exactly one associated state which is the state assigned to the area in which it is located.

The algorithm defines a particular “path” of a potential target at any iteration of the algorithm as a sequence of time-stamped states. The algorithm considers all possible paths, that is, all possible sequences of state values. If the number of discrete states is M, the number of possible paths of length I is M^{I}. For a reasonable number of states (e.g., 1024 for a 32×32 grid) the number of paths to consider exceeds the limits of practicality with just a few observation intervals. The present algorithm overcomes this by applying the Viterbi algorithm, which is described in Viterbi, “Error bounds for convolutional codes and an asymptotically optimum decoding algorithm”, IEEE Transactions on Information Theory 13(2):260-269 (April 1967), the disclosure of which is incorporated herein by reference. This reduces the total number of potential paths to retain for evaluation to a constant value of M*N regardless of the number of iterations. Here N is the number of potential paths in the set to be yielded by the algorithm as having the highest likelihood.

All that is needed to incorporate a particular instance and type of sensor into the algorithm is a function that provides a metric of the likelihood that the particular sensor indication would occur given that there is a target at some given location (i.e., some state location value). The independent variable for each of these functions is the grid location (state location value) of a potential target. For sensors that provide a binary output, as is typical of first and second generation sensors, this consists of two functions. One function yields the likelihood metric for the sensor indication being inactive given that there is a target at the location. The other gives the likelihood metric for the sensor's active indication when a target is at the location. For third generation sensors that provide an indication of suspected target location, a single function is needed that provides the likelihood metric for the sensor reporting a particular target position (or simply azimuth or range) given that the target is actually at the particular location given by the independent variable. These functions can be readily obtained for each particular type of sensor through its specifications and/or direct evaluation of its performance.

The method of the invention can be practiced by implementing in software all or a subset of the algorithm that is described hereafter. This software can be executed on any general purpose processor or set of processors having sufficient computing power and access in approximate real time to the data produced by the sensors. For example, low-cost custom hardware accelerators designed for high-speed video graphics calculations can provide the processing capability required to run the present algorithm in real time.

Further details of various aspects of the method of the invention are described hereafter with respect to the drawings and in the following sections.

### Basic Approach of Fusion Algorithm

The present fusion algorithm provides the operator with an automatically derived confidence level indication as to the presence or absence of one or more intruders. For example, the system may report something like:

Possible intrusion detected with confidence level of 8.

Possible intrusion detected with a confidence level of 6.

No other intrusions detected with confidence levels above 2.

The reported confidence level is only a value on a relative scale and is not related to a formal statistical definition. All that is needed is a metric whose relative value reflects how well the observed sequence of sensor activity corresponds to the presence or absence of an intruder. This is intended to assist the operator in deciding on the appropriate action in view of the system-wide status at the time. The present approach is a notable improvement over other algorithms which are limited to reporting only binary results from the fusion process. The present algorithm directly incorporates object location information provided by third generation sensors. The algorithm also makes use of the fact that a real intruder is a physical object with mobility limitations that restrict what can be considered to be reasonable sequences of observations. In other words, the algorithm attempts to make use of a more extensive history of detections by various sensors in order to assess the degree to which it is “believed” that this sequence has been caused by a particular type of intruder, such as a human on foot, a helicopter as opposed to a fixed wing airplane, etc.

The terms “probability” and “likelihood” are used in the following discussion to give an intuitive view of the reasoning behind the sensor fusion algorithm. In general, the values for these terms provide various metrics indicating a relative degree of confidence that some event has taken place in view of evidence provided by sensors and as processed by the fusion algorithm. These terms are used more or less interchangeably with the term “metric” in the discussion.

In the present approach, the area of interest is overlaid with a grid and the “state” of the system is defined to be the grid location of a target (intruder). Therefore, the system has a finite set of M discrete states:

Sᵢ i=1 . . . M,

where each state corresponds to a specific grid location.

A “possible” state of the system at an iteration (“point in time”) is considered to be one value of Sᵢ. Using the term “iteration” is more accurate than using the term “time” because there is no assumption regarding time relationships other than that time increases monotonically with each iteration. A particular “path” of a target is defined as the current iteration of the algorithm at some particular sequence of G states ending in the state.

The status of sensor k is represented as eₖ and the full set of detection status of K sensors as reported at the current iteration is represented as:

{e}={e₁,e₂, . . . ,e_{K}}

It is necessary to determine a metric for a specific path that expresses a level of “belief” that the path was followed by a target given the complete history of sensor status observed over the most recent G iterations. This is expressed as the probability that a target has been at the sequence of locations defining a path given the history of sensor indications that have been observed over time. The assumption is that the target was at each of these locations on the path at the time a corresponding iteration of the algorithm was executed. It is not essential for this metric to be a true probability value. Instead it need only provide an indication of a relative level of confidence that this sequence occurred, given the sequence of sensor indications (“observations”) that has occurred over time.

In the basic approach, all possible sequences of state transitions of some length are considered and the metric for each one is determined. The paths with the highest metrics that also exceed some thresholds can then be presented to the operator along with the relative level of confidence in each.

A fortunate side effect of considering all possible paths and only attempting to assess their relative likelihood, rather than attempting to select “the” path from the outset, is that the algorithm is able to recognize the presence of multiple intruders (assuming they have multiple paths.)

### Evaluating the Path Metric

In order to continuously provide a security assessment, it is necessary to update all path metrics each time there is a change in sensor status. Intuitively, it should be possible to avoid completely re-evaluating a metric for each possible path at each iteration and instead to determine the new metric iteratively. That is to say that the current path metric is ideally a function of the current set of sensor indications and the path metric for the “prefix” path. The prefix path is the path that includes all locations (states) except the location that is being added to this prefix as of the current iteration. This defines a path metric function that is based on a combination of:

the current set of sensor indications;

the newly appended state itself (representing a physical location); and

the metric that was previously determined for the first “prefix path”, i.e., the path minus the most recently added state.

### Bayes Equation

An expression for the foregoing path metric function is the product of:

the probability that the target is at the newly added state (location) on the path given the set of sensor indications at that iteration; and

the probability of a transition being made by an expected target between from the most recent state on the prefix path and the newly added state during the time interval that has elapsed between the two iterations of the algorithm. Since the state is a two dimensional value, direction of travel between these two states may play a role in this as well as the distance and time interval.

From a practical standpoint, directly determining the probability that an intruder is at a location given the current set of sensor indications (assuming a mix of sensors of multiple generations) is all but impossible. On the other hand, if sensors do not interact with each other, determining values for the probability that a particular set of sensor indications would be observed given that the intruder is at a location is something that is at least approachable. According to Bayes equation:

$$P ( A \vert B ) = \frac{P ( B \vert A ) \cdot P ( A )}{P ( B )}$$

To apply this to the fusion process, the elements of Bayes equation are assigned as follows:

P(A|B)=P(Sᵢ|{e}) This is the conditional probability that the target is at a state given the current set of sensor indications.

P(B|A)=P({e}|Sᵢ) This is the conditional probability of observing the current set of sensor indications given that the target is at a particular state.

P(A)=P(Sᵢ) This is the unconditional probability of the target being at the state.

P(B)=P({e}) This is the unconditional probability of the occurrence of the current set of sensor indications.

Substituting into Bayes equation gives:

$$P ( {S}_{i} \vert \{ e \} ) = \frac{P ( \{ e \} \vert {S}_{i} ) \cdot P ( {S}_{i} )}{P ( \{ e \} )} \qquad ( 1 )$$

Provided that the following two requirements can be met, this relation is an attractive candidate for the basis of determining a path metric:
1) to enable iterative evaluation, the unconditional probability of the target being at the state must somehow be a function of the metric for the prefix path which is the previous conditional probability that the target was at a previous state; and
2) In order to make use of all available information, the evaluation must also take into account the limitations on a target's mobility based on the assumption of a human intruder on foot. This will also have to be included in evaluation of the unconditional probability of the target being at the state since the other two terms have no dependence on the change in the target's location between iterations.
   In order to meet these requirements, it is necessary to define the unconditional probability of the target being at the state as the product of two terms:

P(Sᵢ)=P(Sⱼ|{e})·P(Sⱼ→Sᵢ)

where the two terms on the right are:
1) The path metric for the prefix path; and
2) An assessment of the probability of a transition from this previous state to the current state given the distance and direction between the locations, the time between the iterations and some assumptions about the intruder's mobility. (For example, including this in the evaluation should exclude false targets such as a bird flying through the monitored area.)

Therefore, the unconditional probability of the target being at the state is the product of the path metric for the prefix path and the probability of the transition from the most recent state in the prefix path to the current state. Intuitively this makes sense, saying simply that the probability of the target being at the current location is the product of the probability that the target was actually at the previous state at the start of the interval given the history of observations and transitions up to that time and the probability that a transition could take place from the previous state in the intervening time.

The complete expression for the path metric then becomes:

$$P ( {S}_{i} \vert \{ e \} ) = \frac{P ( \{ e \} \vert {S}_{i} ) \cdot P ( {S}_{j} \to {S}_{i} )}{P ( \{ e \} )} P ( {S}_{j} \vert \{ e \} ) . \qquad ( 2 )$$

This effectively implements a recursion all the way back to the oldest state maintained by the path. This recursion effectively “rolls up” both the impacts of sensor detections and the likelihood of movement by the intruder. The general computational task then becomes the following:
At each iteration, for each possible state Sᵢ, evaluate the path metric for each possible state sequence of length G that terminates in Sᵢ.

The qualifier “possible” is used because it is reasonable to classify some state transitions as “impossible” based on the time interval and distance. An “impossible” state transition removes all paths terminating at a previous state as possible prefixes for paths that include a current state. Although less likely, it can also be decided that some observed sensor status is impossible if a target is at a given location. In this case, the location is not considered as a next state for all existing paths.

At each iteration, for each possible next state for each possible existing prefix path, the computational task is to evaluate the three terms on the right of equation (1).

### Evaluating Probability of Observed Sensor Indication Given a Target Location

The term P({e}|Sᵢ) is the probability that the observed collective sensor status would exist given the target state. As sensors are used that do not interact with each other, it is assumed that the sensor events have independent probability relationships. Therefore, the probability is simply the product of the probabilities for each of the individual sensor indications conditioned on the target being at a given location:

$$P ( \{ e \} \vert {S}_{i} ) = {\prod }_{K} P ( {e}_{k} \vert {S}_{i} )$$

where P(eₖ|Sᵢ) is simply the probability of sensor k having the status that is currently observed, given that the system state is Sᵢ, i.e., the target is at the corresponding grid location.

The following sections describe the approaches used to determine the probability of the observations, meaning the information provided by the sensors, given a specific state, i.e., that the intruder is located in a specific grid cell. Different approaches are required based on the type of sensor.

The expression in the denominator of equation (1), P({e}), is a “normalizing” factor that effectively increases the path metric if the probability of the complete set of sensor indications is low, which is intuitively the desired result. A suitable value for this term can be calculated as part of the process of evaluating P({e}|Sᵢ) for each possible location (which is done at each iteration.) This value is simply the average of all these values.

If the individual cells of the grid are not all the same size, it would be better to compute a weighted average where each term is weighted by the relative size of the grid cell for the associated location. The result can be further improved by including in the summation a term to represent the probability of observing the collective sensor status given that there is no target in the grid.

A. Evaluating Binary Sensors

For a single binary sensor k (such as PIR, buried and fence), the probability of the sensor being active if the state (target location) is (xₕ,yₕ) is represented as:

P_{b}(xₕ,yₕ) (3)

Since (3) applies to just a single point in the horizontal plane, integrating over the dimensions of one cell and dividing by the area gives the average probability of the sensor being active given that the target is in a given cell.

$${P}_{k} ( i ) = \frac{1}{{D}^{2}} \cdot {\int }_{{X}_{i} - \frac{D}{2}}^{{X}_{i} + \frac{D}{2}} {\int }_{{Y}_{i} - \frac{D}{2}}^{{Y}_{i} + \frac{D}{2}} {P}_{b} ( {x}_{h} , {y}_{h} ) d {y}_{h} d {x}_{h} \qquad ( 4 )$$

where (Xᵢ,Yᵢ) are the coordinates of the center of the cell for state Sⱼ and D is the length of the side of a cell. If binary sensor k is active:

P(eₖ|Sᵢ)=Pₖ(i) (5)

If binary sensor k is not active:

P(eₖ|Sᵢ)=1−Pₖ(i) (6)

The active case (5) appears to present a problem. If the location Sᵢ is not within the detection area of sensor k, it may not be reasonable to assign a low probability to the sensor being active because it could be responding to a real target at some other location. Likewise, if the location Sᵢ is within the detection area of sensor k, it may not be reasonable to assign a high probability to the sensor being active for the same reason. The inactive case (6) does not have the same problem. It is reasonable to assign a high probability if the location is not within the detection area and a low probability if the location is within the detection area. However, in reality, the algorithm has no notion of where an intruder may or may not be. With regard to binary sensors, the overriding objectives are:
1) If a sensor is active, paths that currently end in states that are within the sensor's detection area should have an increase in their metrics over paths that currently end in states that are not within this area.
2) If a sensor is not active, paths that currently end in states that are not within the sensor's detection area should have an increase in their metrics over paths that currently end in states that are within this area.

Provided the probability values are never zero or one, the logic given in (5) and (6) appears to be able to achieve this objective. Since the path metric is computed purely as a product, injecting a probability value of zero effectively “kills” the path completely, eliminating any future chance of having its metric rise to compete with the metrics of other paths.

B. Evaluating Video Analytics

For detection information generated by video analytics, computing P(eₖ|Sᵢ) is a little more involved. Video analytics processing provides a periodic “object report” in which the estimated location (in pixels) in the video image plane is given for each tracked object. It can be assumed that there is some error in the reported location of the object so that there is a probability distribution for reported locations relative to the actual location of the object:

Pᵥ(xₑ,yₑ|xᵥ,yᵥ) (7)

where (xₑ,yₑ) is the reported object location and (xᵥ,yᵥ) is the actual location, both expressed as pixel indices in the video image plane.

To incorporate the object reports into the fusion process, an expression is needed for the probability of a given reported location based on the object's actual location, both of these being in the state plane (typically earth's surface). To do this the image plane probability distribution is projected onto the state plane:

Pₕ(xₑ,yₑ|xₕ,yₕ)=Pᵥ(xₑ,yₑ|Tₓ(xₕ,yₕ), T_{y}(xₕ,yₕ)) (8)

where (xₕ,yₕ) is the actual target location in the earth's surface plane and Tₓ(x,y) and T_{y}(x,y) transform horizontal plane coordinates into image plane coordinates. These transforms are geometric relations based on the camera location in three dimensions relative to the state plane and the camera orientation and field of view, which are assumed to be constants.

Since (8) applies to just a single point in the horizontal plane, in order to get the average probability for all locations in a state grid cell, it is necessary to integrate over the dimensions of one cell and divide by the area:

$$P ( {e}_{k} \vert {S}_{i} ) = \frac{1}{{D}^{2}} \cdot {\int }_{{X}_{i} - \frac{D}{2}}^{{X}_{i} + \frac{D}{2}} {\int }_{{Y}_{i} - \frac{D}{2}}^{{Y}_{i} + \frac{D}{2}} {P}_{v} ( {x}_{e} , {y}_{e} \vert {T}_{x} ( {x}_{h} , {y}_{h} ) , {T}_{y} ( {x}_{h} , {y}_{h} ) ) d {y}_{h} d {x}_{h} \qquad ( 9 )$$

where (Xᵢ,Yᵢ) are the coordinates of the center of the cell for state Sᵢ and D is the length of the side of a cell. It should be noted that this does not require the camera's field of view to include the entire area covered by the location state grid. For cells whose state Sᵢ lies well outside the field of view, equation (9) should evaluate to zero, meaning video analytics will not report this object's location as being somewhere within its field of view.

For video analytics there is an important case that is not addressed by equation (9). For binary sensors, it is assumed that the detection status is always known. However, with video analytics it is necessary to deal with the case in which no object report is received. This can happen whether or not there is an intruder. For example, the intruder may be standing still or partially or fully hidden. One can argue that the absence of a video analytics object report should somehow result in a reduction in confidence levels meaning a reduction in path metrics. However, the reduction would have to be applied across the board to all currently possible states within the camera's field of view (since there is no basis for doing otherwise.) If the primary objective is to determine relative confidence levels for a set of paths, the simplest way to deal with the case of no report is to ignore it. This means that the video analytics object reports should be considered as part of the set {e} when the reports are received, and not part of the set otherwise.

Each video analytics report of a detected object may beneficially include a “track” identifier to indicate if video analytics believes the object is in fact the same one whose location was previously reported with the same identifier. This can be included in the fusion process using the following logic: If a path includes a state that previously fell within the probability zone of a video analytics object location, the reported track number is saved with that path. In evaluating the path metric, the transition probability is lowered if the saved track identifier does not match the identifier for the recently reported object for which the next state is being evaluated.

C. Evaluating Seismic Sensors

Analyzing the correlations of signals received by multiple point seismic sensors at the edge of an area can provide location information for a target inside the area. This can also provide location information for targets outside this area. However, it appears that limiting the detection to the direction of the target's location relative to the sensor set may provide more reliable results in this case. If use of seismic sensors is limited to analyzing the signals received by individual sensors, it may still be possible to provide an estimation of the range of the target from the sensor (based on signal amplitude). Otherwise, the fusion process would treat a seismic sensor as another type of binary sensor.

For each of the first three cases above (point location, direction and range), uncertainty in the analysis results is expressed as a complex two-dimensional probability distribution that is offset within the state grid. In the case of direction information, the distribution is also rotated based on the detection results.

It is assumed that seismic sensors are located at the edges of the protected area such that it is not necessary to include direction-only information in the fusion process. For the case of point locations, the problem is similar to that described for video analytics with the exception that the transform from ground to video planes is not needed. A relation is needed for the probability of a location being reported given some actual location:

Pₛ(xₑ,yₑ|xₕ,yₕ)

where (xₑ,yₑ) is the reported object location and (xₕ,yₕ) is the actual location.

Again, in order to get the average probability for a state grid cell, it is necessary to integrate over the dimensions of one cell and divide by the area.

$$P ( {e}_{k} \vert {S}_{i} ) = \frac{1}{{D}^{2}} \cdot {\int }_{{X}_{i} - \frac{D}{2}}^{{X}_{i} + \frac{D}{2}} {\int }_{{Y}_{i} - \frac{D}{2}}^{{Y}_{i} + \frac{D}{2}} {P}_{s} ( {x}_{e} , {y}_{e} \vert {x}_{h} , {y}_{h} ) d {y}_{h} d {x}_{h} \qquad ( 10 )$$

where (Xᵢ,Yᵢ) are the coordinates of the center of the cell for state Sᵢ and D is the length of the side of a cell.

For the case of range-only information provided by single sensors, the probability distribution has only a single dimension, i.e., range, but, assuming the speed of sound through the earth is the same in all directions, it has angular symmetry:

Pₛ(dₑ|dₕ)

where dₑ is the reported object distance from the sensor and dₕ is the actual distance of the object from the sensor. The following is then used to obtain the average probability over an entire cell.

$$P ( {e}_{k} \vert {S}_{i} ) = \frac{1}{{D}^{2}} \cdot {\int }_{{X}_{i} - \frac{D}{2}}^{{X}_{i} + \frac{D}{2}} {\int }_{{Y}_{i} - \frac{D}{2}}^{{Y}_{i} + \frac{D}{2}} {P}_{s} ( {d}_{e} \vert \sqrt{{( {X}_{k} - {x}_{h} )}^{2} + {( {Y}_{k} - {y}_{h} )}^{2}} ) d {y}_{h} d {x}_{h} \qquad ( 11 )$$

where (Xₖ,Yₖ) is the location of seismic sensor k.

### Evaluating Transition Probability

The second term in the numerator in equation (2), the transition probability, P(Sⱼ→Sᵢ), indicates the likelihood that an intruder could have moved from a previous location (Sⱼ) to the current location (Sᵢ) during the time that elapsed between iterations. Both locations could be the same, which is entirely possible for a stationary or slowly moving object. Both target velocity and acceleration can be estimated based on previous states in the path:

$${{s}^{{.}^{}}}_{i} = \frac{{{s}^{}}_{i} - {{s}^{}}_{j}}{{T}_{i} - {T}_{j}}$$

$${{s}^{{¨}^{}}}_{i} = \frac{{{s}^{{.}^{}}}_{i} - {{s}^{{.}^{}}}_{j}}{{T}_{i} - {T}_{j}}$$

where Tᵢ is the clock time at the current iteration, etc., so that:

$$P ( {S}_{j} \to {S}_{i} ) = {F}_{Δ} ( {{s}^{}}_{i} , {{s}^{{.}^{}}}_{i} , {{s}^{{¨}^{}}}_{i} ) . \qquad ( 12 )$$

The actual function for F_{Δ} may have to be derived empirically and then experimentally verified. It may end up being fairly involved. For example, it may be useful to reduce the probability for acceleration direction and magnitude as velocity increases. Given the real world limits on human mobility, it is reasonable for F_{Δ} to evaluate to zero in some cases. The function may also take into account the direction of motion relative to the current position, taking advantage of the likely case of intruders having specific location objectives.

Since video analytics is not intended to detect a stationary object, in the case where no detection is reported by video analytics, it is possible to modify F_{Δ} so that it falls off much more rapidly with velocity. In other words, there would be a strong preference for all states to transition only to themselves. Similar logic could be used when detections of the same object (same “track ID”) are reported in sequence by changing F_{Δ} to favor velocities implied by the distance between the reported positions and the time interval between reports.

### Initiating an Iteration

As indicated previously, no assumptions have been made regarding time intervals, etc. A question remains then as to what are the circumstances that initiate an iteration. In general, path metrics should be evaluated whenever new information is available from one or more sensors. For a binary sensor, this happens whenever there is a change in the detection status. For a video analytics source, it is receipt of a report of the objects detected in a video frame. For a seismic sensor, it could be receipt of a report that is sent periodically whether or not there has been a change in the results of its acoustic signal analysis. A report that a seismic sensor is not detecting any activity may be information that the fusion process should consider. Ideally, an iteration should be done for each of these events individually.

At the other extreme is the case where the site is completely secure and none of the sensors are reporting new information or one or more binary sensors are reporting the same state continuously. In this case, in order to gradually age out the older sensor inputs, iterations should continue based on some maximum time interval. This is a “polling” initiation as opposed to one that is event driven.

In general, a combination of event-driven and polling initiation of an evaluation should be used so as to bound the maximum time between iterations and to provide immediate assessment when there is sensor activity.

### Operating in a Dynamic Environment

Real-world physical security systems must operate continuously and detect an intrusion that may occur at any point in time. In this environment, there can be no “time=0” at which metric evaluation for every possible path begins. Obviously, the metric evaluation time span for a path approximating that of a real intruder should be closely aligned with the time during which the intrusion occurs. In order to accommodate this dynamic environment, a given path must have beginning and ending times. Outside of this interval, the path's history of locations is not of interest because it is unlikely that they match those of a real intruder. One technique of tracking a changing environment that has been applied successfully is to simply ignore information whose age exceeds some limit. This has been referred to as “aging out” the data.

The path metrics should reflect only relatively recent sensor events. This can be done by removing the contributions to the path metric of the locations on the path for which the time that has elapsed since those locations were added exceeds some threshold. Since all paths are updated at each iteration, this has the effect of truncating all paths to some length G (the number of locations in the set that constitutes the path) which can be done simply by selectively removing the oldest number of locations from each path at each iteration based on the time that has elapsed since that location was added. With this approach, when there is low or no sensor activity, the time intervals between nodes will be at the maximum value as determined by the polling interval. Paths will be truncated to shorter lengths (lower values of G) when limiting the maximum “age” of the oldest nodes on each path. This is appropriate because there will be little or no change in the metrics between iterations. Conversely, when there is a lot of sensor activity, there will be a larger number of locations on each path since the time intervals between adding these is shorter (because evaluation is event driven by sensor activity.) Again this is appropriate in that it allows the algorithm to retain and thereby consider more information at this time.

### Elapsed Time Weighting Path Metrics

As described so far, the algorithm gives no consideration to the ordering of the observed and derived values of P({e}|Sᵢ), P({e}) and P(Sⱼ→Sᵢ) versus time. Intuitively, it may be desirable for more recent events to have more weight in determining the metric. Again, since we are concerned only with relative values of the path metrics, this can be done fairly easily. If all paths have the same length, a single weighting factor can be maintained for all paths. This factor is increased by some amount at each iteration. Because the factors in equations (1) and (2) are combined via multiplication, the weighting must be done by raising the factors that depend on the current information to a power. This changes equation (4) to the following:

$$P ( {S}_{i} \vert \{ e \} ) = {( \frac{P ( \{ e \} \vert {S}_{i} ) \cdot {P}_{Δ} ( {S}_{j} \to {S}_{i} )}{P ( \{ e \} )} )}^{{f}_{W} ( i )} \cdot P ( {S}_{j} \vert \{ e \} ) \qquad ( 13 )$$

where f_{W}(i) is the weighting factor that decreases for the older locations on the path.

The cost of using this weighting is that equation (2) cannot be computed iteratively using the metric for the prefix path because this metric changes at each iteration due to age-weighting of the locations on the path.

### No Active Sensor Indications

It is useful to consider what indications the algorithm can be expected to give when the monitored area is secure and no sensors are active. When a binary sensor is off, the path metric is decreased for the locations that are inside the sensor's detection area. The logic is that the probability of an off indication is low if a target is in one of these locations. If all sensors are off, locations that are in the detection area of two sensors will have their metrics lowered more than those in the area of only one sensor. The overall result will be that the areas with the highest path metrics will be those for which the sensor coverage is weakest. The algorithm is saying simply that, given the current sensor states, if there are any intruders, they are most likely to be in the areas that have the worst coverage. If scaling and thresholds are set correctly, the highest path metrics will be reported with confidence levels that are low enough that the site can be considered to be secure. If, in this quiet state, a single sensor becomes active, the metrics for the paths through the locations that are in this sensor's detection area will be increased relative to the others.

### Reducing the Number of Paths to Maintain

If the number of discrete states is M, the number of possible paths after I iterations is M^{I}. For a reasonable number of states (1024 for a 32×32 grid) the number of paths to track goes beyond the limits of practicality with just a few iterations. By using the Viterbi algorithm, and making one key assumption, it is not necessary to keep track of all possible paths. In fact, to track a single target, it is only necessary to maintain one path for each of the discrete states, no matter how many iterations there are.

The key assumption is that the change to the path metric as a result of a particular state transition depends only on the starting and ending states of that transition. Consider the new set of paths formed by the set of paths entering a state and one path exiting this state. The extension of each of the entering paths by the exiting path will result in a change to each path's metric. If we can assume that this change depends only on the starting and ending states of the new path segment, then the metrics for all of these paths will be changed by the same amount. Therefore, since the change in the metric due to the exiting path is the same for all paths in this set, within this exiting set of paths, the path with the highest metric must be the one that includes the entering path having the highest metric. This is true for any path exiting the state. At each iteration, each state that is reachable can be reached by up to M paths. It is then necessary to determine the new metric for each of these paths. However, once this is done, only the path having the highest metric needs to be remembered. All of the remaining paths can be disregarded. Therefore, no matter how many iterations are made, to track a single target, a maximum number of M paths needs to be retained for consideration at the next iteration.

Tracking Multiple Targets with the Viterbi Algorithm

In order to track a maximum of R targets, the Viterbi algorithm must be modified so that each state retains R paths. At each iteration, there will be M·R possible paths that reach any given state of which the paths having the R highest metrics are retained. The present algorithm uses this approach to keep track of the R paths terminating in each state having the highest metric. In general, a maximum value of R must be set at design time but lower values can be used in operation depending on the circumstances.

### Effects of “Aging Out” Path Locations

As stated previously, path metrics can be kept more “current” by removing locations on the path based on the time elapsed since these were added and/or weighting metrics based on elapsed time. In either case, the metric of the affected path is reduced. As discussed above, when using the Viterbi algorithm, a limited number of paths (R) is maintained for each state. Reducing the metric of paths whose “strongest” nodes occurred prior to the current aging threshold (or farther back in time) effectively improves the competitive position of all candidate paths now being considered to be one of the R paths to be retained for that state.

Thus, reducing the strength of existing paths based on elapsed time enables the emergence of new paths having stronger current metrics and this in turn leads to the demise of older paths since only the strongest set of paths will be retained for each state. True paths, i.e., those that closely correspond to an intruder's motion, should be able to retain their competitive stance as the boost given to metrics by more recent sensor activations compensates for the loss of the contributions of the older locations. False paths, however, will not have the benefit of this “replenishment” and consequently should be reliably deleted.

### Determining Initial Values

It may appear that there is a need to provide an initial value of the path metric to start the recursion in equation (2). However, at the time a path is selected for inclusion in the set of R paths that are retained by a state, this path is already one of the R full length paths held by each of the other M states. So the path is already initialized. The only time this is not true is for the first G-l iterations. What is needed then, is to establish this complete set of M*R G-length paths at initialization. This can be easily done while the monitored area is free of all intruders so that all sensors remain inactive.

An initial value of G is set based on the path node age limit and the polling rate. A complete set of R paths each including G locations are established for each of the M states. The metrics are all set to their lowest values (i.e., unity). After this, the algorithm is run with periodic iterations initiated via polling for several times the maximum path length. This achieves the desired steady state condition for no intruders in which all of the path metrics are based on the sensor coverage for their associated locations as described previously.

Considering Acceleration when Using the Viterbi Algorithm

The approach to calculating the transition probability P(Sⱼ→Sᵢ) as discussed previously violates the key assumption that enables use of the Viterbi algorithm. This is because two states prior to the new one are needed in order to calculate the acceleration vector

$$( {{s}^{{¨}^{}}}_{i} ) .$$

In order to use acceleration in determining transition probability, the velocity vector

$$( {{s}^{{.}^{}}}_{i} )$$

must be included as part of the state and, since the state must be discrete, the velocity vector needs to be quantized (in two dimensions.) Even with fairly coarse quantization (e.g., 4-8 levels), this would inflate the already substantial state space to a size that may be impractical. To avoid this and still use the Viterbi algorithm to keep the number of tracked paths to a manageable value, acceleration is not used. The transition probability function (12) is redefined as:

$$P ( {S}_{j} \to {S}_{i} ) = {F}_{Δ} ( {{s}^{}}_{i} , {{s}^{{.}^{}}}_{i} ) \qquad ( 14 )$$

Intuitively, acceleration may not be especially useful for tracking a human on foot and attempting to use acceleration may provide a way for an intruder to defeat the fusion algorithm by deliberately moving erratically.

### Previous State Pruning Based on Assumed Human Mobility Limits

It can be assumed that there is some reasonable maximum velocity for a human on foot. If the evaluation intervals are sufficiently short, for any given next state the number of possible previous states is limited by the distance that would have to be covered during the evaluation interval. This can significantly reduce the number of state transitions to evaluate at each iteration. However, it does not reduce the number of paths that have to be maintained. Since it is assumed that the true location cannot be known for certain, all states are always potential next states. The assumptions about mobility locations can only limit the number of paths that can potentially lead to a given state.

A world-class sprinter may cover up to 10 meters in one second. If the evaluation interval is one second, the protected area is a square 50 meters on a side, and the state grid is 32×32, the maximum number of previous states is about

$$\frac{π \cdot {10}^{2}}{{( 50 / 32 )}^{2}} ≅ 129$$

This is an 87% reduction versus the 1024 previous states per current state for which the metric would have to be evaluated otherwise.

### Fusion Algorithm Diagrams

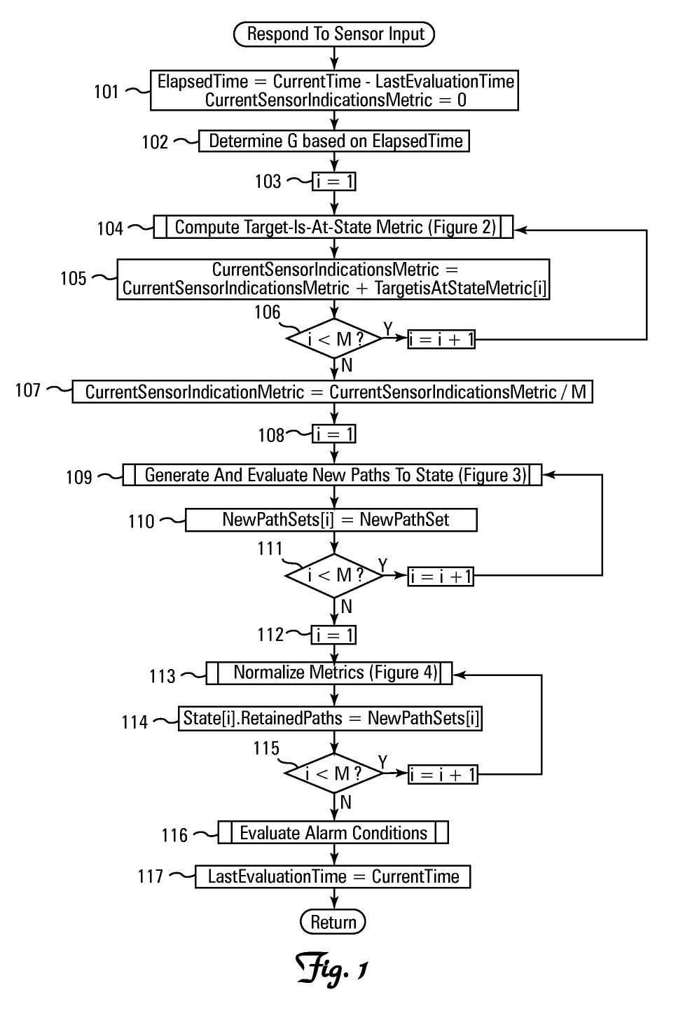

FIGS. 1-11 are flow diagrams depicting various aspects of the fusion algorithm of the present invention. The following tables provide definitions for the various structure types, constants, and variables used in the algorithm.

TABLE 1
Structure Type Definitions

| Type | | Member | |
|---|---|---|---|
| Name | Member Name | Type | Description |
| Location | | | Represents position of a |
| | | | target. |
| | X | Numeric | Horizontal grid coordinate. |
| | Y | Numeric | Vertical grid coordinate. |
| Speed | | | Represents speed vector of a |
| | | | target. |
| | DeltaX | Numeric | Horizontal change in |
| | | | position. |
| | DeltaY | Numeric | Vertical change in position. |
| StateInfo | | | |
| | Loc | Location | Grid location for the State |
| | RetainedPaths | Array of R | The set of R paths that |
| | | Path | currently terminate in a State |
| | | structures | having large enough metrics |
| | | | to be retained for further |
| | | | consideration. |
| PathNode | | | Represents a single node on |
| | | | a Path, i.e., a previous State |
| | | | location. |
| | StateIndex | Integer | Index for the State (location) |
| | | | at this point along a Path. |
| | StateEntryMetric | Numeric | The portion of the metric for |
| | | | a Path ending at this State |
| | | | that depends only on the |
| | | | current State, i.e., excluding |
| | | | the metric for the prefix |
| | | | path. The complete Path |
| | | | metric is the product of the |
| | | | StateEntryMetric values for |
| | | | all G Path Nodes on a Path. |
| Path | | | Represents a single Path |
| | | | through the monitored area. |
| | Metric | Numeric | The calculated metric for the |
| | | | Path |
| | Nodes | Array of G | The sequence of State |
| | | PathNode | (location) values |
| | | structures | representing a potential path |
| | | | of a target. |
| SensorInfo | | | Represents information |
| | | | about a single sensor that is |
| | | | used by the algorithm. |
| | ProvidesTargetLocation | Boolean | True for sensors that can |
| | | | provide some location |
| | | | information about a detected |
| | | | target, e.g., radar, video |
| | | | analytics. |
| | NewTargetLocationReported | Boolean | True if this sensor is |
| | | | providing a new target |
| | | | location report for the |
| | | | current algorithm iteration. |
| | ReportedTargetLocation | Location | Target location being |
| | | | reported by this sensor. |
| | SensorIsActive | Boolean | Valid for sensors that do not |
| | | | report location information |
| | | | such as passive infra-red. |
| | | | True if the sensor is |
| | | | indicating a target detection. |

TABLE 2
Constant Definitions

| Constant | Constant | |
|---|---|---|
| Name | Type | Description |
| M | Integer | Total number of States (locations) in the grid that |
| | | is super-imposed over the monitored area. |
| R | Integer | Total number of Paths (ending at that State) that |
| | | are retained for each State after each iteration of |
| | | the algorithm. |
| K | Integer | Total number of sensor devices providing input to |
| | | the algorithm. |

TABLE 3
Variable Definitions

| | Variable | |
|---|---|---|
| Variable Name | Type | Description |
| i | Integer | Index used to iterate over the StateInfo[M] array to |
| | | identify the current state used for evaluation (the |
| | | most recent location on a potential path). |
| j | Integer | Index used to iterate over StateInfo[M] array to |
| | | identify the previous state used for evaluation (the |
| | | previous location on a potential path). |
| r | Integer | Index used to iterate over the RetainedPaths[R] array |
| | | for a given State. |
| rNew | Integer | Index used to track locations in the NewPath array of |
| | | Paths while it is being populated with new Paths. |
| rChk | Integer | Index used only to search the NewPath array of Paths |
| | | to find the Path in the array having the weakest |
| | | metric. |
| g | Integer | Index used to iterate over the Nodes[G] array for a |
| | | given Path. |
| k | Integer | Index used to iterate over the Sensor[K] array. |
| G | Integer | Total number of locations kept for each retained path |
| | | to define the history of locations along that path. |
| | | This is constant across each iteration of the algorithm |
| | | but is changed to control path truncation based on the |
| | | time elapsed between iterations. |
| WeakestPathIndex | Integer | Index into the RetainedPaths[R] array of the |
| | | StateInfo structure that identifies the currently |
| | | retained Path having the weakest metric. This Path |
| | | will be replaced whenever a new Path ending in this |
| | | state is evaluated with a metric stronger than this |
| | | value. |
| ElapsedTime | Numeric | The time that has elapsed since the last iteration of |
| | | the algorithm. This is used to determine whether a |
| | | state transition being considered is consistent with the |
| | | assumptions about target mobility. |
| CurrentTime | Numeric | The effective time for the current iteration of the |
| | | algorithm. Note that this does not have to be true |
| | | clock time if all sensor activity reports are |
| | | accompanied by time stamps. |
| LastEvaluationTime | Numeric | The effective time for the previous iteration of the |
| | | algorithm. Used to determine ElapsedTime. |
| CurrentSensorIndicationsMetric | Numeric | This is a “normalizing” value that reflects the overall |
| | | likelihood of the set of sensor indications that exist at |
| | | the time of the current iteration of the algorithm. The |
| | | normalizing effect is that the likelihood of the current |
| | | set of sensor indications assuming that the target is at |
| | | a given location is made to be relative to the overall |
| | | likelihood of that set of sensor indications. |
| StateTransitionMetric | Numeric | This value is an indication of the likelihood that a |
| | | particular transition between two given States has |
| | | taken place during ElapsedTime. It is based on |
| | | assumptions regarding the mobility of the expected |
| | | intruder and can also consider the likelihood of |
| | | direction of travel since this is known from the |
| | | locations of the previous and current States. |
| NewPathEvaluationMetric | Numeric | This value is used to determine the relative strength |
| | | of new Paths entering a particular current state. It is |
| | | based on only the components of the path metric that |
| | | are unique to a particular transition which are the |
| | | PrefixPathMetric and the StateTransitionMetric. The |
| | | value is the product of these two terms. |
| PrefixPathMetric | Numeric | This is the path metric for the Path that is the prefix |
| | | for a new Path ending in the current State. If time |
| | | weighting is used, it is the product of the weighted |
| | | StateEntryMetric for each PathNode on this Path. |
| | | Otherwise, it is just the metric that was calculated for |
| | | the prefix Path (one of the R retained Paths for the |
| | | previous State) at the last iteration. |
| WeightedStateEntryMetric | Numeric | This is the weighted value of the StateEntryMetric |
| | | for a PathNode that is calculated when time |
| | | weighting of state entry metrics is used to determine |
| | | the PrefixPathMetric. Since this metric is calculated |
| | | as a product of the weighted StateEntryMetric values, |
| | | the weighting must be done by taking the |
| | | StateEntryMetric to a power that is lower for the |
| | | older PathNodes. |
| ReportedTargetLocationMetric | Numeric | This value is used for the contribution to the |
| | | TargetIsAtStateMetric of a current State for a sensor |
| | | that reports location information with a detection |
| | | report. It reflects the likelihood that the sensor would |
| | | give this location information given that the target is |
| | | actually at the location of this current State. |
| BinarySensorStateMetric | Numeric | This value is used for the contribution to the |
| | | TargetIsAtStateMetric of a current State for a sensor |
| | | that does not report location information with a |
| | | detection report. If the sensor is active/inactive, it |
| | | reflects the likelihood that the sensor would be |
| | | active/inactive given that the target is actually at the |
| | | location of the current State. |
| TargetIsAtStateMetric | Numeric | This array has an entry for each current State (each |
| | [M] | value of i). Each entry reflects the likelihood that the |
| | | complete set of current sensor indications would |
| | | occur given that there is a target at the location of the |
| | | particular State. |
| State | StateInfo | This array has an entry for each State (each location |
| | [M] | in the grid). Each entry stores the location definition |
| | | and the set of retained Paths that end at this location. |
| Sensor | Sensor | This array has an entry for each sensor providing |
| | Info[K] | input to the algorithm. Each entry stores information |
| | | about the sensor and its most recently reported status |
| | | which is used by the algorithm. |
| NewPath | Path | This is a temporary Path structure used to hold the |
| | | path definition for a new path being evaluated. The |
| | | Path is formed by appending a transition to the |
| | | current State to a Path that was retained in the last |
| | | iteration of the algorithm. |
| NewPathSet | Path[R] | This is the set of new paths that have been retained |
| | | by the current iteration for a given State (value of i) |
| | | after considering all possible paths ending in this |
| | | State. |
| NewPathSets | Path | This is the set of new paths that have been retained |
| | [M][R] | by the current iteration for all States (all values of i). |
| RequiredSpeed | Speed | This is the two dimensional velocity that an intruder |
| | | would have to average over the time since the last |
| | | iteration in order to make the transition between from |
| | | the previous location (for State[j]) to the current |
| | | location (for State[i]). |

### Evaluation of the Path Metric

The following explains the approach employed to calculate the path metrics that are used to determine which paths are retained as prefix paths for future paths and which provide an indication of the likelihood that an alarm condition exists as of the current iteration. Also, discussed is how the path metric is calculated within the sequence as embodied in the flow diagrams of FIGS. 1-11 using the variable names that are used in the diagrams.

The complete path metric is calculated according to the following:

$$\frac{\begin{matrix}TargetIsAtStateMetric [ i ] * StateTransitionMetric * \\ PrefixPathMetric\end{matrix}}{CurrentSensorIndicationsMetric}$$

For the sake of efficiency, to find the criterion for selection of the set of new paths that are to be retained for a particular state, only the portion of this metric which is unique to a new path is initially evaluated for each possible new path. This is:

NewPath.Metric=NewPathEvaluationMetric=StateTransitionMetric*PrefixPathMetric

After the set of retained new paths entering a State has been determined, the metrics for the retained paths only are corrected for the current set of sensor indications as they apply to this State.

NewPathSet[r].Metric=NewPathSet[r].Metric*TargetIsAtStateMetric[i]

After the retained paths for all States have been determined, their partially computed metrics are “normalized” for the current set of sensor indications to produce the complete path metric as follows:

NewPathSets[i][r].Metric=NewPathSets[i]][r].Metric/CurrentSensorIndicationsMetric

In order to support time-weighting of sensor indications and past transitions so that the older these get the less impact they have on the path metric, the StateEntryMetric is maintained for each PathNode. This is the portion of the path metric that is independent of the prefix path and reflects only the conditions at that iteration that pertain to a transition into that State location.

NewPathSets[i][r].Nodes[1].StateEntryMetric=TargetIsAtStateMetric[i]*StateTransition Metric/CurrentSensorIndicationsMetric

The full path metric without time weighting can be calculated as the product of the StateEntryMetric value for each PathNode on a Path.

The following table summarizes the steps carried out by the fusion algorithm of the invention according to the flow diagrams of FIGS. 1-11.

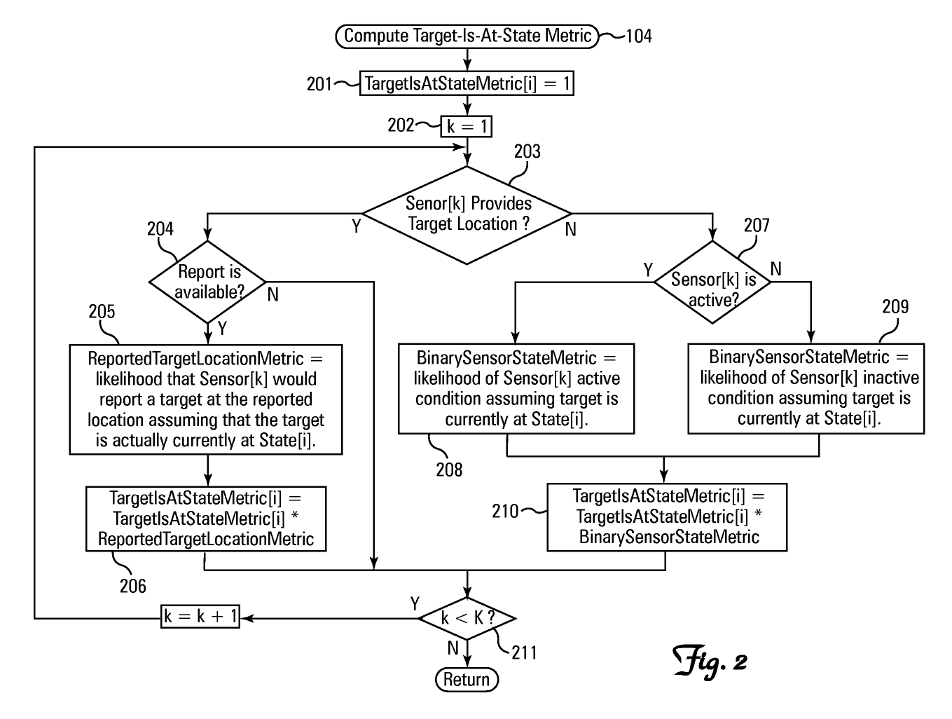

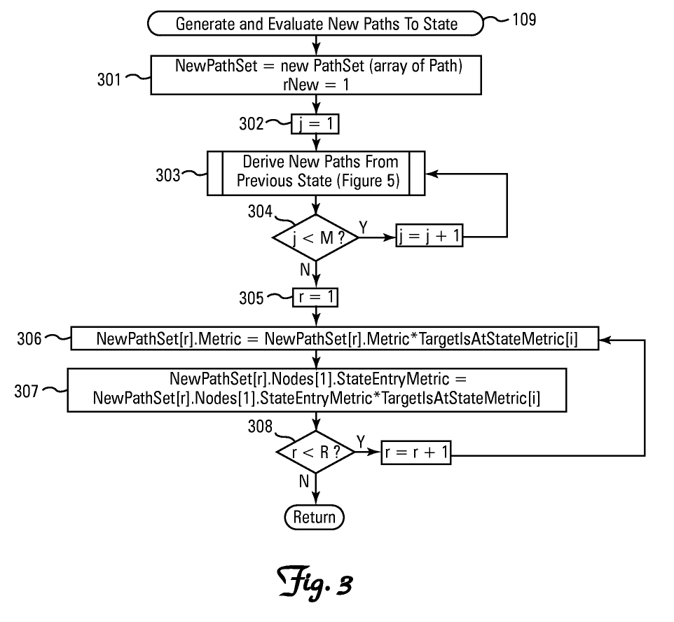

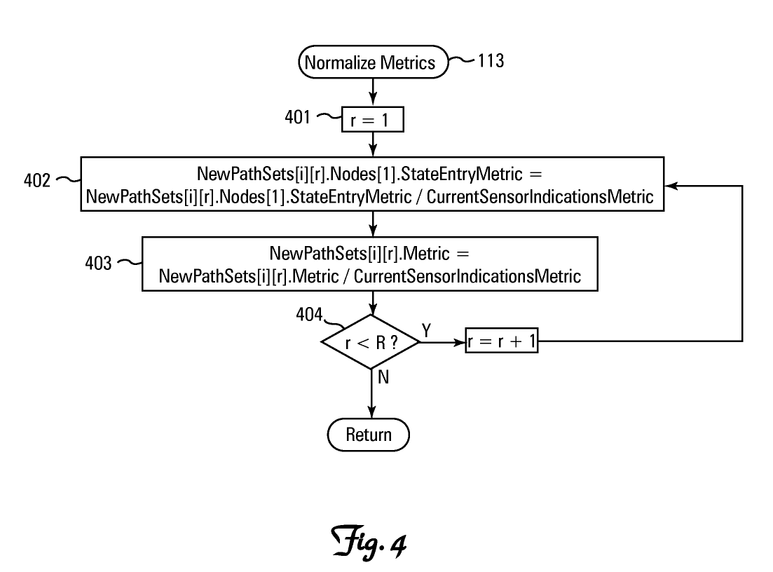

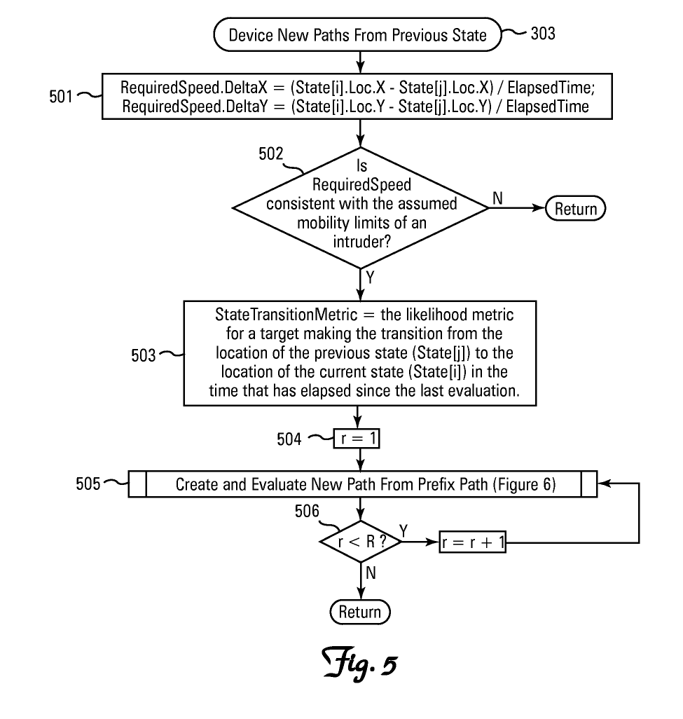

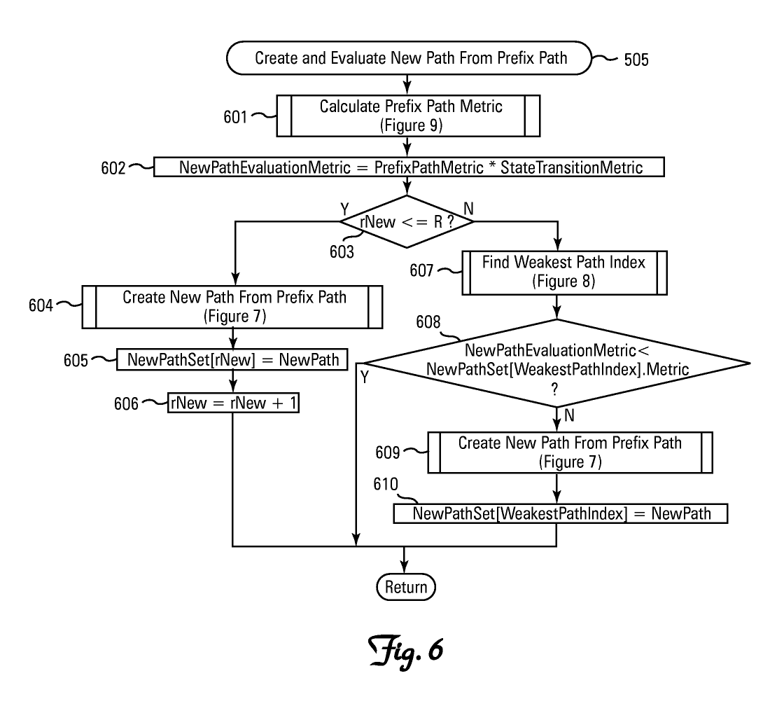

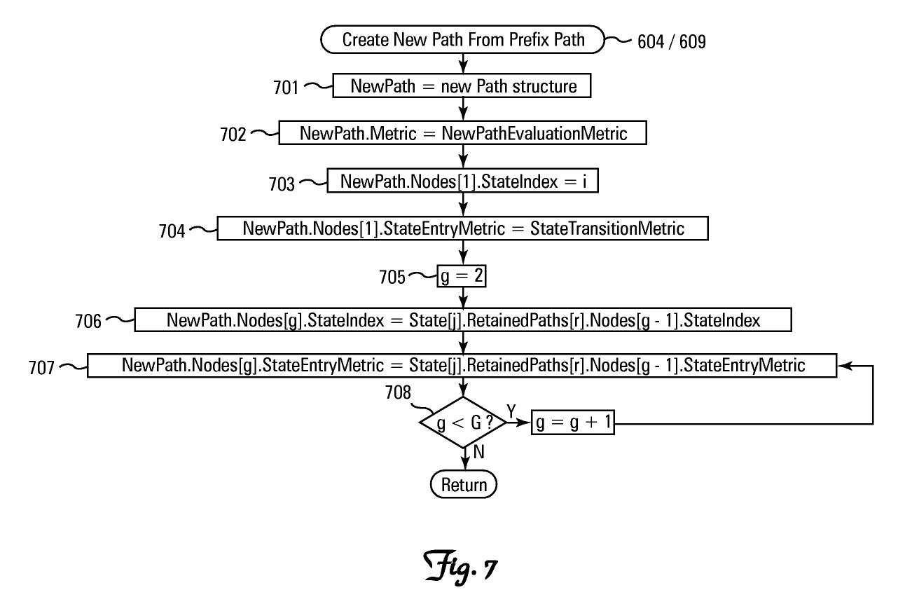

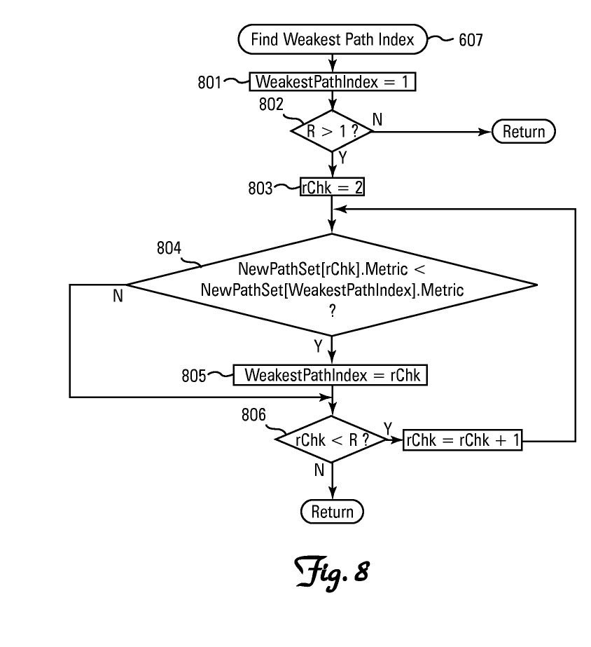

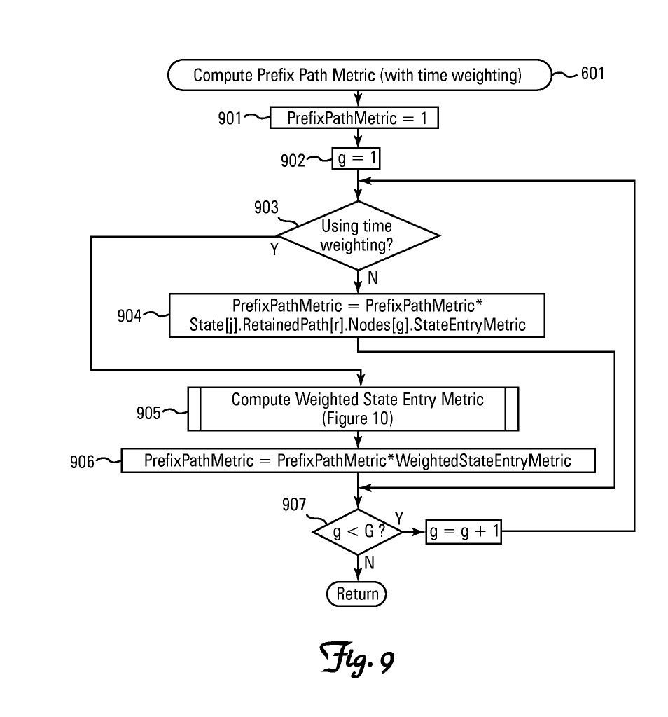

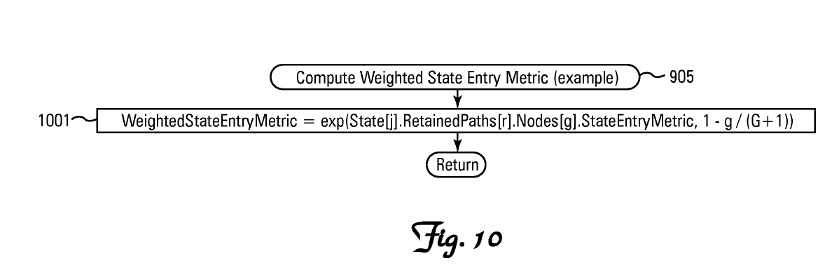

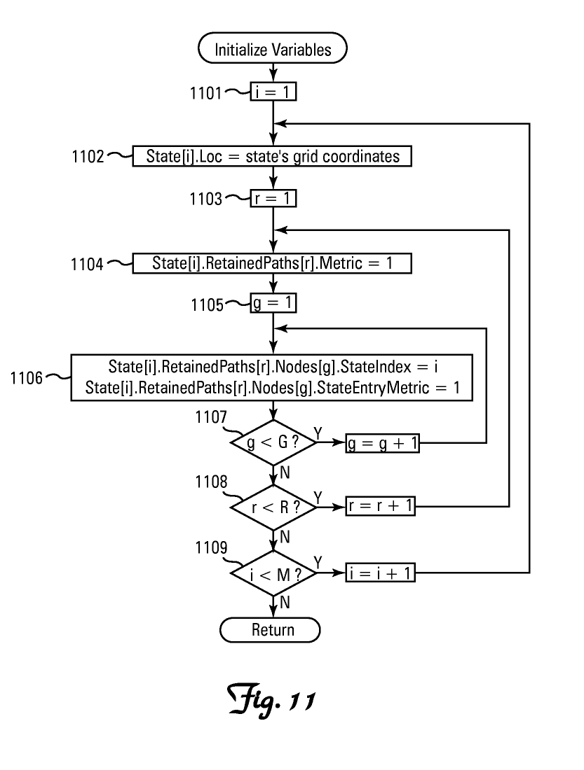

TABLE 4
Fusion Algorithm Steps

| FIG. | Step | Description |
|---|---|---|
| 1 | 101 | In response to sensor input, determine time elapsed from the time reference |
| | | used for the previous iteration to the time reference used |
| | | for the current iteration. Initialize variable for accumulation. |
| | 102 | Determine the value of G, the number of PathNodes in each retained |
| | | new path including the nodes added to the prefix paths in this |
| | | iteration. |
| | 103 | Initialize index for iteration over all values of State[i] as used for the |
| | | current state. |
| | 104 | Invoke procedure to compute TargetIsAtState metric for State[i]. |
| | | (See FIG. 2) |
| | 105 | Accumulate TargetIsAtState metrics into |
| | | CurrentSensorIndicationsMetric for all States. This assumes |
| | | uniform size grid cells so there is no size weighting of the |
| | | component values. |
| | 106 | Check for end of iteration. |
| | 107 | Replace the accumulation in CurrentSensorsIndicationsMetric with |
| | | the arithmetic mean. |
| | 108 | Initialize index for iteration over all values of State[i] as used for the |
| | | current state. |
| | 109 | Invoke procedure to generate and evaluate all possible new Paths to |
| | | State[i]. (See FIG. 3) |
| | 110 | Save the new set of Paths that have been retained for State[i] in the |
| | | NewPathSets array of NewPathSet. |
| | 111 | Check for end of iteration. |
| | 112 | Initialize index for iteration over all values of State[i] as used for the |
| | | current state. |
| | 113 | Invoke procedure to normalize the metrics for all retained Paths for |
| | | State[i]. (See FIG. 4) |
| | 114 | Replace the set of Paths retained for State[i] during the previous |
| | | iteration (this iteration's “prefix” Paths) with the new Paths that |
| | | were created, evaluated and retained for this iteration. |
| | 115 | Check for end of iteration. |
| | 116 | Invoke a procedure to evaluate the metrics for the set of Paths |
| | | retained by all States to determine if an alarm condition exists. A |
| | | specific procedure is not shown in the flow diagrams as this |
| | | evaluation can be done in a number of ways. For example, an alarm |
| | | condition can be automatically declared if any metric exceeds a |
| | | statically set threshold. Another approach would be to display a |
| | | fixed number of Paths having the highest metrics to an operator for |
| | | the operator to then make a decision. An alternative to this would |
| | | be to display the set of Paths now having a metric that exceeds some |
| | | threshold to allow an operator to further assess the situation. Either |
| | | of the latter two approaches has the benefit that the actual physical |
| | | Path can be illustrated to help the operator assess the likelihood that |
| | | this is the path of a real intruder. |
| | 117 | Save the time reference used for this iteration. |
| 2 | 201 | Initialize variable (1 instead of 0 because “accumulation” is a |
| | | product, not a sum). |
| | 202 | Initialize index for iteration over all sensors in the system. |
| | 203 | Branch to handle sensors that give target location information |
| | | differently from sensors that provide only a binary alarm indication. |
| | 204 | Bypass accumulation of metric for Sensor[k] if a new target |
| | | detection report is not currently available. |
| | 205 | Derive the likelihood metric for the report currently received from |
| | | Sensor[k]. This would typically be done via a lookup into a table of |
| | | previously computed values. The values may depend on both the |
| | | direction from the reported location to the location of State[i] and |
| | | the distance between the two. |
| | 206 | “Accumulate” via multiplication the metric for Sensor[k] into the |
| | | metric for this State. |
| | 207 | Branch based on active/inactive state of binary Sensor[k]. |
| | 208 | Derive the likelihood metric for Sensor[k] having active state given |
| | | there is a target at the location of State[i]. |
| | 209 | Derive the likelihood metric for Sensor[k] having inactive state |
| | | given there is a target at the location of State[i]. |
| | 210 | “Accumulate” via multiplication the metric for Sensor[k] into the |
| | | metric for this State. |
| | 211 | Check for end of iteration. |
| 3 | 301 | Create a new array of R Paths and assign to NewPathSet. Initialize |
| | | iteration index. |
| | 302 | Initialize index for iteration over all values of State[j] as used for the |
| | | previous state. |
| | 303 | Invoke procedure to derive a new set of Paths for using the set of |
| | | retained paths for State[j] as the prefix with added extension from |
| | | State[j] to State[i]. (See FIG. 5) |
| | 304 | Check for end of iteration. |
| | 305 | Initialize index for iteration over all Paths in the new set of retained |
| | | Paths. |
| | 306 | Adjust path metric for each Path in the new set of retained Paths (all |
| | | ending at State[i]) to account for the set of likelihood metric for the |
| | | observed set of sensor indications under the assumption that the |
| | | target is currently at State[i]. |
| | 307 | Adjust the StateEntryMetric for the new PathNode (for State[i]) for |
| | | each Path in the new set of retained paths to account for the set of |
| | | likelihood metric for the observed set of sensor indications under the |
| | | assumption that the target is currently at State[i]. |
| | 308 | Check for end of iteration. |
| 4 | 401 | Initialize index for iteration over all Paths in the new set of retained |
| | | Paths for State[i]. |
| | 402 | Normalize the StateEntryMetric for the new PathNode (for State[i]) |
| | | for each Path in the new set of retained paths by dividing by a |
| | | metric indicating the likelihood of occurrence of the current set of |
| | | sensor indications with no assumptions regarding target location. |
| | 403 | Normalize the path metric for each Path in the new set of retained |
| | | paths by dividing by a metric indicating the likelihood of occurrence |
| | | of the current set of sensor indications with no assumptions |
| | | regarding target location. |
| | 404 | Check for end of iteration. |
| 5 | 501 | Determine the required average velocity in each dimension for a |
| | | target that has moved from State[j] to State[i] in the time that has |
| | | elapsed since the last iteration. |
| | 502 | If the required velocity (and possibly direction) is not consistent |
| | | with assumptions about the mobility of the expected target, exit the |
| | | procedure. |
| | 503 | Obtain (calculate or look up) a metric indicating the likelihood that a |
| | | target has moved from State[j] to State[i] in the last time interval. |
| | 504 | Initialize index for iteration over new Paths. |
| | 505 | Invoke procedure to create and evaluate a new Path using a path |
| | | retained by State[j] as the prefix path and extended by a transition |
| | | from State[j] to State[i]. (See FIG. 6) |
| | 506 | Check for end of iteration. |
| 6 | 601 | Invoke procedure to calculate the metric for the prefix path. This |
| | | calculation optionally applies time weighting to the |
| | | StateEntryMetrics for each PathNode. (See FIG. 9) |
| | 602 | Calculate the metric that will be used to compare the new Paths all |
| | | ending in State[i] (R paths from every State[j]) to determine which |
| | | Paths are retained for subsequent iterations of the algorithm. |
| | 603 | Branch based on whether all the elements in the NewPathSet array |
| | | have been assigned a new Path. |
| | 604 | Invoke procedure to create a new Path to State[i] using one of the |
| | | Paths retained by State[j] as the prefix. (See FIG. 7) |
| | 605 | Assign the newly created Path to the next free element in the |
| | | NewPathSet array. |
| | 606 | Increment the index that tracks unassigned locations in the |
| | | NewPathSet array. |
| | 607 | Invoke procedure to find the index of the Path in the NewPathSet |
| | | array having the weakest metric. (See FIG. 8) |
| | 608 | If the metric of the newly created Path is less than the weakest |
| | | metric currently in the NewPathSet, exit the procedure. |
| | 609 | Invoke procedure to create a new Path to State[i] using one of the |
| | | Paths retained by State[j] as the prefix. (See FIG. 7) |
| | 610 | Replace the Path in the NewPathSet having the weakest metric with |
| | | the newly created Path. |
| 7 | 701 | Create a new Path structure and assign it to NewPath |
| | 702 | Set the Metric member of NewPath to the |
| | | NewPathEvaluationMetric previously calculated. |
| | 703 | Set the StateIndex member of the first PathNode in NewPath to the |
| | | current state index (i). |
| | 704 | Set the StateTransitionMetric member of the first PathNode in |
| | | NewPath to the previously calculated StateTransitionMetric. |
| | 705 | Initialize the index to iterate over the PathNodes in NewPath that |
| | | preceed the newest PathNode in time. |
| | 706 | Copy the StateIndex from the corresponding PathNode in the prefix |
| | | path. |
| | 707 | Copy the StateEntryMetric from the corresponding PathNode in the |
| | | prefix path. |
| | 708 | Check for end of iteration. |
| 8 | 801 | Initialize the WeakestPathIndex to 1 (assume the first element has |
| | | the weakest metric) |
| | 802 | If only one Path is being retained for each State, exit the procedure. |
| | 803 | Initialize the index to iterate over the Paths in NewPathSet after the |
| | | first element. |
| | 804 | If the Path at the iteration index does not have a weaker metric than |
| | | the path currently identified by WeakestPathIndex, continue to |
| | | check the metric of the next Path. |
| | 805 | Set the index of the weakest path to the current iteration index. |
| | 806 | Check for end of iteration. |
| 9 | 901 | Initialize the path metric to be computed for “accumulation” via |
| | | multiplication. |
| | 902 | Initialize the index for iteration over the PathNodes in the Path. |
| | 903 | Branch based on whether or not time-weighting of |
| | | StateEntryMetrics is being used. |
| | 904 | “Accumulate” path metric using the PathNode's StateEntryMetric |
| | | value directly (no time weighting). |
| | 905 | Invoke a procedure to compute a weighted value for the |
| | | StateEntryMetric saved for the PathNode at the iteration index. The |
| | | weighting should be such that Nodes for older states get less weight. |
| | | FIG. 10 shows an example of such a procedure. |
| | 906 | “Accumulate” the time-weighted value of the StateEntryMetric. |
| | 907 | Check for end of iteration. |
| 10 | 1001 | Compute a time-weighted value of the PathNode's StateEntryMetric |
| | | by taking this to a power that decreased for increasing values of the |
| | | iteration index. Exponentiation is used as opposed to multiplication |
| | | because the “accumulation” is done using multiplication instead of |
| | | addition. |
| 11 | 1101 | Initialize index for iteration over all States. |
| | | (The initialization routine of FIG. 11 is run after startup and any time |
| | | there is a need to restart the algorithm, such as after a number of |
| | | authorized people have moved through the monitored area). |
| | 1102 | Set the location for the State. |
| | 1103 | Initialize index for iteration over all retained Paths for the State. |
| | 1104 | Initialize the Metric for the Path. |
| | 1105 | Initialize index for iteration over all PathNodes in the Path. |
| | 1106 | Initialize the StateIndex to the current State. This means that the |
| | | Path is that of a target that stays at this State for G iterations of the |
| | | algorithm. |
| | 1107 | Check for end of iteration. |
| | 1108 | Check for end of iteration. |
| | 1109 | Check for end of iteration. |

Instructions for carrying out the various process tasks, calculations, and generation of signals and other data used in the operation of the methods of the invention can be implemented in software, firmware, or other computer readable instructions. These instructions are typically stored on any appropriate computer readable media used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media; or any other media that can be used to carry or store desired program code in the form of computer executable instructions or data structures. Any of the foregoing may be supplemented by, or incorporated in, specially-designed application-specific integrated circuits (ASICs) or field programmable gate arrays (FPGAs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

The methods of the invention can be implemented by computer executable instructions, such as program modules, which are executed by a processor. Generally, program modules include routines, programs, objects, data components, data structures, algorithms, and the like, which perform particular tasks or implement particular abstract data types. Computer executable instructions, associated data structures, and program modules represent examples of program code means for executing steps of the methods disclosed herein. The particular sequence of such executable instructions or associated data structures represents examples of corresponding acts for implementing the functions described in such steps.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A method of sensor data fusion, the method comprising:
receiving data inputs from one or more sensors in a physical security system of a monitored area overlaid with a grid defining a plurality of locations;
selecting one or more potential paths of one or more potential intruders through the monitored area using an iterative process, taking into consideration a sequence of sensor inputs and assumed limitations on mobility of the one or more potential intruders; and
producing a confidence metric for each selected potential path.

2. The method of claim 1, wherein the security system has a finite set of discrete states that each correspond to a different grid location, and the one or more potential paths at any iteration comprise a sequence of time-stamped states.

3. The method of claim 1, further comprising triggering an alarm condition when the confidence metric exceeds a predetermined threshold.

4. The method of claim 1, further comprising displaying one or more paths in which the confidence metric exceeds a predetermined threshold to allow an operator to assess a situation.

5. The method of claim 1 wherein, for each of the one or more sensors providing a binary output, the method incorporates:
a likelihood metric for a sensor being inactive when there is an intruder at a grid location; or
a likelihood metric for a sensor being active when there is an intruder at a grid location.

6. The method of claim 1, wherein the one or more sensors comprise direct contact sensors, or remote sensing sensors.

7. The method of claim 1, wherein the one or more sensors comprise switches, magnetically activated relays, electric eyes, passive infrared sensors, or microwave proximity sensors.

8. The method of claim 1, wherein the one or more sensors comprise target location estimating sensors.

9. The method of claim 1, wherein the one or more sensors comprise radar, light detection and ranging sensors, video analytics, or seismic sensor arrays.

10. A method of sensor data fusion in a physical security system for a monitored area, the method comprising:
(a) receiving data inputs from one or more sensors in the physical security system, wherein the monitored area is overlaid with a grid defining a plurality of locations;
(b) determining an elapsed time from a difference between a time reference for a current iteration and a time reference used for a previous iteration in response to the inputs from the one or more sensors;
(c) determining a total number of locations kept in one or more retained paths based on the elapsed time, including the locations added to one or more prefix paths in the current iteration;
(d) initializing an index for iteration over all state values used for a current location;
(e) computing a target-is-at-state metric at the current location;
(f) accumulating a target-is-at-state metric into a current-sensor-indication metric for all locations in the grid;
(g) repeating steps (e) and (f) if the number of the current iteration is less than a total number of locations in the grid;
(h) replacing the current-sensor-indication metric with an arithmetic mean;
(i) initializing an index for iteration over all state values used for the current location;
(j) generating and evaluating all possible new paths to the current location;
(k) storing a new set of paths that have been retained for the current location;
(l) repeating steps (j) and (k) if the number of the current iteration is less than the total number of locations in the grid;
(m) initializing an index for iteration over all state values used for the current location;
(n) normalizing one or more metrics for all retained paths for the current location;
(o) replacing the prefix paths with the new paths in the current iteration;
(p) repeating steps (n) and (o) if the number of the current iteration is less than the total number of locations in the grid;
(q) evaluating the metrics for all retained paths to determine if an alarm condition exists; and
(r) storing the time reference used for the current iteration.

11. The method of claim 10, wherein computing the target-is-at-state metric in step (e) further comprises:
(i) initializing the target-is-at-state metric to be one;
(ii) initializing an index for iteration over all of the one or more sensors in the physical security system;
(iii) if a sensor provides a target location, determining whether a new target detection report is currently available;
(iv) if a new target detection report is currently available:
deriving a reported-target-location metric;
accumulating the target-is-at-state metric based on a multiplication of the reported-target-location metric with the current target-is-at-state metric; and
skipping to step (x);
(v) if a new target detection report is not currently available, skipping to step (x);
(vi) if the sensor does not provide a target location, determining whether the sensor is active;
(vii) if the sensor is active, deriving a binary-sensor-state metric of likelihood that the sensor is active given that there is a target at the current location;
(viii) if the sensor is inactive, deriving a binary-sensor-state metric of likelihood that the sensor is inactive given that there is a target at the current location;
(ix) accumulating the target-is-at-state metric based on a multiplication of the binary-sensor-state-metric with the current target-is-at-state metric;
(x) if the iteration number is less than the total number of sensors, repeating steps (iii) to (ix).

12. The method of claim 10, wherein generating and evaluating all possible new paths in step (j) further comprises:
(i) creating a new set of retained paths for each location after each iteration;
(ii) initializing an iteration index for a previous location on a potential path;
(iii) initializing an index for iteration over all state values as used for the previous location;
(iv) deriving a set of new paths for using the retained paths for the previous location as the prefix path with added extension from the previous location to the current location;
(v) if the iteration number used for the previous location is less than the total number of locations in the grid, repeating step (iv);
(vi) initializing an index for iteration over all paths in the new set of retained paths;
(vii) adjusting the path metric for each path in the new set of retained paths ending at the current location to account for the set of likelihood metrics for the observed set of sensor indications under the assumption that the target is at the current location;
(viii) adjusting the state-entry-metric for a new path node for the current location for each path in the new set of retained paths to account for the set of likelihood metrics for the observed set of sensor indications under the assumption that the target is at the current location; and
(ix) if the iteration number of the new set of retained paths is less than the total number of paths retained for each location in the grid, repeating steps (vii) and (viii).

13. The method of claim 10, wherein normalizing one or more metrics for all retained paths in step (n) comprises:
(i) initializing an index for iteration over all paths in the new set of retained paths for the current location;
(ii) normalizing the path metric for each path in the new set of retained paths by dividing by a metric indicating the likelihood of occurrence of the current set of sensor indications with no assumptions regarding target location;
(iii) normalizing the path metric for each path in the new set of retained paths by dividing by a metric indicating the likelihood of occurrence of the current set of sensor indications with no assumptions regarding target location; and
(iv) if the iteration number is less than the total number of paths retained for each location in the grid, repeating steps (ii) and (iii).

14. The method of claim 12, wherein deriving a set of new paths in step (iv) comprises:
determining the required average velocity in each of an x-coordinate and a y-coordinate for a target that has moved from a previous location to the current location in the time that has elapsed since the last iteration;
if the required velocity is consistent with assumptions about the mobility of the target, obtaining a metric indicating the likelihood that a target has moved from a previous location to the current location in the last time interval;
initializing an index for iteration over the new paths;
creating and evaluating a new path using paths retained by the previous location as prefix paths and extended by a transition from the previous location to the current location;
if the iteration number is less than the total number of paths retained for each location in the grid, repeating the previous step;

15. The method of claim 14, wherein creating and evaluating a new path comprises:
calculating a prefix path metric;
calculating a new path evaluation metric for comparing the new paths all ending in the current location to determine which paths are retained for subsequent iterations;
determining whether all elements in the new path set are assigned to a new path;
if all elements in the new path set are assigned to a new path: creating a new path to the current location using one of the paths retained by the previous location as the prefix path;
assigning the newly created path to the next free element in the new path set; and
incrementing the index that tracks unassigned locations in the new path set; and
if all elements in the new path set are not assigned to a new path:
finding the index of the path in the new path set having the weakest metric;
if the metric of the newly created path is not less than the weakest metric currently in the new path set, creating a new path to the current location using one of the paths retained by the previous location as the prefix path; and
replacing the path in the new path set having the weakest metric with the newly created path.

16. The method of claim 15, wherein creating a new path to the current location comprises:
creating a new path structure;
setting a new path metric based on the new path evaluation metric previously calculated;
setting a state index member of a first path node in the new path to the current state index.
setting a state transition metric member of the first path node in the new path to a previously calculated state transition metric.
initializing an index to iterate over the path nodes in the new path that precedes the newest path node in time;
copying a state index from a corresponding path node in the prefix path;
copying a state entry metric from a corresponding path node in the prefix path;
if the iteration number for the path nodes is less than the total number of paths retained for each location in the grid, repeating the immediately preceding step.

17. The method of claim 15, wherein finding the index of the path in the new path set having the weakest metric comprises
a) initializing a weakest path index to one;
b) if more than one path is being retained for each location, initializing the weakest path index to iterate over the paths in the new path set after the first element;
c) if the path at the index of the current iteration does not have a weaker metric than the path currently identified by the weakest path index:
continue checking the metric of the next path; and
setting the index of the weakest path to the index of the current iteration;
d) if the iteration number for the new path is less than the total number of paths retained for each location in the grid, repeating step c).

18. The method of claim 15, wherein calculating the prefix path metric comprises:
a) initializing the path metric to be computed for accumulation via multiplication;
b) initializing an index for iteration over the path nodes in the path;
c) if time weighting is not being used, accumulating a path metric using the path node state entry metric value directly;
d) if time weighting is being used:
computing a weighted value for the state entry metric stored for the path node at the index of the current iteration; and
accumulating the time-weighted value of the state entry metric;
e) if the iteration number over the path nodes is less than the total number of paths retained for each location in the grid, incrementing the index for iteration over the path nodes and repeating the method starting at step c).

19. The method of claim 18, wherein computing the weighted value for the state entry metric comprises:
computing a time-weighted value of the path node state entry metric by taking the path node state entry metric to a power that decreases for increasing values of the index for iteration over the path nodes.

20. A computer program product, comprising:
a computer readable medium having instructions stored thereon for a method of sensor data fusion in a physical security system according to claim 1O.
